(19) United States
(12) Patent Application Publication
(10) Pub. No.: US 2014/0279382 A1
(43) Pub. Date: Sep. 18, 2014

(54) Credit Monitoring and Simulation Aggregation System

(71) Applicants: Erin E. Drakeley, Norwell, MA (US); Raji Subramaniam, Holliston, MA (US)

(72) Inventors: Erin E. Drakeley, Norwell, MA (US); Raji Subramaniam, Holliston, MA (US)

(73) Assignee: FMR LLC

(21) Appl. No.: 13/828,397

(22) Filed: Mar. 14, 2013

(51) Int. Cl. G06Q 40/02

(52) U.S. Cl. CPC G06Q 40/025
USPC 705/38

(57) ABSTRACT

A computer-implemented method comprising: determining, by a credit management system, credit information of a user, by: receiving, by the credit management system, account information of the user, with the account information specifying balance information indicative of account balances in one or more financial accounts of the user; and receiving, by the credit management system, debt information of the user, with the debt information specifying balance information indicative of outstanding debts in the one or more financial accounts of the user; and generating, based on the received balance and debt information, a personal credit management proprietary score for the user.

### BACKGROUND

This invention generally relates to computer-based management of credit scores.

An identify protection system may monitor usage of a user's identifying information (e.g., name and address information, social security information, and so forth) to detect when a malicious user is attempting to steal the user's identity and/or attempting to use the user's identify for malicious purposes.

### SUMMARY

In general, in one aspect, a computer-implemented method comprises: determining, by a credit management system, credit information of a user, by: receiving, by the credit management system, account information of the user, with the account information specifying balance information indicative of account balances in one or more financial accounts of the user; and receiving, by the credit management system, debt information of the user, with the debt information specifying balance information indicative of outstanding debts in the one or more financial accounts of the user; and generating, based on the received balance and debt information, a personal credit management proprietary score for the user.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In particular, one embodiment may include all the following features in combination. Implementations may include one or more of the following features. In some implementations, the features include adjusting a value of the personal credit management proprietary score based on proprietary adjustment rules.

In yet other implementations, the features include retrieving, by the credit management system from a plurality of credit bureau systems, credit bureau scores of the user; generating, based on the personal credit management proprietary score and based on the retrieved credit bureau scores, a simulated credit score for the user; and adjusting a value of the simulated credit score based on one or more of the credit information and the account information.

In still other implementations, the features include accessing a mapping of personal credit management proprietary scores to score conditions, with the score conditions being based on account balances and credit bureau scores; and identifying that one of the score conditions in the mapping is satisfied by the credit information of the user; wherein generating the personal credit management proprietary score for the user comprises: selecting a personal credit management proprietary score that is mapped in the mapping to the identified one of the score conditions. In some implementations, the features include retrieving, by the credit management system from a plurality of credit bureau systems, credit bureau scores of the user; and assigning weighted values to one or more of the personal credit management proprietary score and the retrieved credit bureau scores; wherein generating the simulated credit score for the user comprises: computing a weighted average of the personal credit management proprietary score and one or more of the retrieved credit bureau scores, with the weighted average being in accordance with the weighted values assigned to the one or more of the personal credit management proprietary score and the retrieved credit bureau scores.

In still other implementations, the features include receiving, from a computing device used by the user, information indicative of a selection of one or more actions for one or more credit bureau systems to perform; identifying, from the received information, one or more of the credit bureau systems to be notified of the user's request for performance of the one or more actions; and transmitting, to the identified one or more of the credit bureau systems, a notification message of the user's request for performance of the one or more actions.

There are various advantages to the techniques described herein, including, e.g., that customers become more active in the monitoring of their credit health and protecting their credit rating and assets. By working with the credit bureaus to provide a secure and encrypted electronic channel for monitoring of credit activity, the system will reduce issues with mail fraud and other paper related threats such as identity theft. The system increases efficiencies through real-time updates as well as reduces cost and paper currently hindering the credit monitoring options available today. With increased functionality to interact directly with credit bureaus and integrate with related services (provided by financial institutes), the system strengthens the customer experience and relationship with various financial institutions.

### BRIEF DESCRIPTION OF THE FIGURES

FIG. 1 is a diagrammatic view of a credit management system.

FIGS. 2-7 are examples of graphical user interfaces presented to a user of the credit management system.

FIGS. 8 and 9 are flow charts useful in understanding the credit management system.

FIG. 10 is a block diagram of typical components for devices in the system of FIG. 1.

### DETAILED DESCRIPTION

Referring now to FIG. 1, an example system 100 implementing a credit management service is shown. System 100 includes a network 102, a client device 104, a financial system 111, a credit management server 108, credit bureau servers 110, 112 and a data repository 109. A user (not shown) uses client device 104 to access the credit management server 108 via the network 102. The client device 104 and the credit management server 108 communicate with each other over network 102 and can run programs having a client-server relationship to each other. Credit management server 108 is associated with and/or operated by a financial institution (e.g., a financial institution that maintains financial account(s) 120). Financial system 111 includes credit management server 108 and brokerage engine 113. Brokerage engine 113 is configured to execute one or more financial transactions and/or to implements systems for maintaining financial accounts.

Client device 104 sends request 114 to credit management server 108. Request 114 is a request to view aggregated credit information for the user. Request 114 also includes identifying information for the user (e.g., a user name and a password). Credit management server 108 receives request 114. In response, credit management server 108 parses contents of request 114 to obtain the identifying information. Using the identifying information, credit management server 108 sends requests (not shown), to credit bureau servers 110, 112, for credit information of the user. Credit information includes credit scores of the user (e.g., as calculated by the various credit bureaus) and other types of information, including, e.g., information specifying accounts (e.g., credit cards, financial accounts, etc.) that are recently opened, information specifying accounts that are closed, information specifying activity that has taken place in various accounts of the user, and so forth. In response to the request, credit bureau servers 110, 112 access credit information 116, 118, respectively for the user. Credit bureau servers 110, 112 transmit credit information 116, 118, respectively, to credit management server 108. Credit information 116, 118 includes credit scores for the user of client device 104.

Using the identifying information in request 114, credit management server 108 accesses, in data repository 109, financial account(s) 120 of the user. There are various types of financial account(s), including, e.g., savings accounts, retirement accounts, checking accounts, 401(k) accounts, brokerage accounts, and so forth. Following accessing of financial account(s) 120, credit management server 108 determines an amount of balances (e.g., cash balances) in one or more of financial account(s) 120.

Using credit information 116, 118 and/or the contents of financial account(s) 120, credit management server 108 computes a simulated credit score 122 for the user of client device 104. Credit management server 108 executes various rules in computing simulated credit score 122. Simulated credit score 122 provides a value indicative of a simulation of a credit score (e.g., a credit bureau score) if the credit score takes into account information (of a user) that specifies balance information indicative of account balances in one or more financial accounts of the user and debt information of the user, with the debt information specifying balance information indicative of outstanding debts in the one or more financial accounts of the user, along with other types of financial account information and/or credit information. That is, the simulated credit score 122 may include a proprietary credit score (generated by a financial institution, such as Fidelity) that acts as (e.g., imitates) a score that is generated by a credit bureau, if the credit bureau score was generated based on financial account information.

Credit management system 108 generates simulated credit score 122 by executing an algorithm and/or a series of rules that implement the operation of a real-world process for generating a credit score (e.g., a credit bureau score), with algorithm and/or series of rules using credit bureau scores, financial account information and/or credit information of the user. In an example, simulated credit score 122 is a personalized credit score of a user that is based on various types of different credit scores, financial account information and/or credit information. Simulated credit score 122 may also be referred to as financial institution credit score, e.g., a proprietary credit score that is generated by a financial institution (e.g., the financial institution associated with financial system 111). The financial institution credit score is generated using the techniques described herein.

In one example, simulated credit score 122 includes a value that is based on a combination of one or more credit bureau scores and the personal credit management proprietary score. In another example, the simulated credit score 122 includes a value that is based on a combination of one or more credit bureau scores, one or more weighted credit bureau scores, a personal credit management proprietary score, and/or a weighted personal credit management proprietary score. In still another example, the simulated credit score 122 includes a value that is based on (and/or is the same as) the personal credit management proprietary score.

In one implementation, simulated credit score 122 is an average of the credit scores included in credit score information 116, 118 from credit bureau servers 110, 112, respectively. In another implementation, simulated credit score 122 is a weighted average of the credit scores included in credit score information 116, 118 from credit bureau servers 110, 112, respectively. Credit management server 108 assigns weighted values to the credit scores. The sum of the weighted values has a value of one or 100%. The weighted value specifies an amount of importance credit management server 108 assigns to a credit score relative to an amount of important credit management server 108 assigns to the other credit score. Credit management server 108 is programmed (e.g., by an operator) with information specifying weighted values to be applied to the credit scores received from the various credit bureaus.

In another implementation, credit management server 108 generates a personal credit management proprietary score that is a credit score that is calculated with proprietary rules that are specific to credit management server 108, and in general would be a different set of rules from that used by commercial credit bureaus. Credit management server 108 generates the personal credit management proprietary score in accordance with the mapping shown in the below Table 1.

TABLE 1

| | Personal credit management |
|---|---|
| Score Condition | proprietary score |
| Aggregated fund balances greater than debt | 750 |
| score | |
| Aggregated fund balances <= debt score | 725 |
| Aggregated fund balances 50% less than | 675 |
| debt score | |
| zero fund balances | 500 |

As shown in the above Table 1, credit management server 108 uses a comparison of aggregated account balances in financial account(s) 120 with a debt ratio (e.g., a credit bureau score and/or information derived from a credit bureau score) in selecting a personal credit management proprietary score. The debt ratio is also referred to as a debt score. Aggregated account balances in financial account(s) 120 are an amount of funds (e.g., cash) in financial account(s) 120. The debt ratio may include one of the credit bureau scores included in credit information 116, 118. The debt ratio may also include another value that is derived from the credit bureau scores included in credit information 116, 118, including, e.g., an average of the credit bureau scores included in credit information 116, 118, a weighted average of the credit bureau scores included in credit information 116, 118, and so forth.

In Table 1, various score conditions (that are based on aggregate fund balances and on debt scores) are mapped to various personal credit management proprietary scores. The mapping of Table 1 specifies that when the aggregated fund balances in financial account(s) 120 are greater than the debt score that the personal credit management proprietary score has a value of seven-hundred fifty. The mapping also specifies that when the aggregated fund balances are less than or equal to the debt score that the personal credit management proprietary score has a value of seven-hundred twenty-five. The mapping also specifies that when the aggregated fund balances are fifty percent less than the debt score that the personal credit management proprietary score has a value of six-hundred seventy-five. The mapping also specifies that when the aggregated fund balances are zero that the personal credit management proprietary score has a value of five hundred.

Using the selected personal credit management proprietary score and one or more of the credit bureau scores included in credit information 116, 118, credit management server 108 generates a simulated credit score, e.g., by computing a weighted average of the personal credit management proprietary score and one or more of the credit bureau scores included in credit information 116, 118 or by computing an average of the personal credit management proprietary score and one or more of the credit bureau scores included in credit information 116, 118. Credit management server 108 is programmed (e.g., by an operator) with information specifying weighted values to be applied to the credit scores received from the various credit bureaus and to the personal credit management proprietary score. In another implementation, management server 108 assigns the selected personal credit management proprietary score to be the simulated credit score 122.

In one implementation, credit management server 108 uses various other types of information in generating the simulated credit score and/or in generating the personal credit management proprietary score. These various other types of information may be referred to herein as adjustment information, as these various other types of information are used as factors in adjusting (e.g., increasing and/or decreasing) a calculated simulated credit score and/or in adjusting a personal credit management proprietary score. Adjustment of the simulated credit score generated an adjusted simulated credit score. Adjustment of the personal credit management proprietary score generates a new, adjusted personal credit management proprietary score.

Types of adjustment information include cash and savings accounts information (e.g., brokerage balances, date opened information for the brokerage accounts, balance information for the brokerage accounts, information specifying external checking and savings accounts held outside system 100 and/or outside of credit management server 108, information specifying a date opened for these external accounts, and balance information for these long term accounts. Still other types of adjustment information include information indicative of long term assets, e.g., 401(k) accounts, IRA accounts, trust accounts, a loan and so forth. For a 401(k) account, the information may include a data opened and a balance. For a loan (e.g., a mortgage), the information may include a loan history, a data opened, a date closed, a length of the loan, and so forth. Yet other types of adjustment information includes assets planned for another person's consumption (e.g., a charitable gift balance, 529 Balances, etc.). Still other types of adjustment information include a balance across a portfolio of accounts of the user and information indicative of credit card offerings (e.g., credit Bank name, interest rates, penalties, fees, application guidelines, and so forth).

Credit management system 108 also considers home ownership positively in adjusting a simulated credit score. Another type of adjustment information is information specifying whether a user owns a home or a residence. Still another type of adjustment information is information specifying a length of time in which a user has held savings accounts and a savings and checking history. Holding savings accounts positively impacts a user's simulated credit score. Savings and checking history also positively impact the simulated credit score, e.g., by adjusting the simulated credit score upwards. Still another type of adjustment information a length of employment with a same company, which positively increases the simulated credit score.

Yet another type of adjustment information is information indicative of opening of new accounts (e.g., credit card accounts, savings accounts, and so forth), which is a detriment to the simulated credit score (e.g., decreases the simulated credit score). Still another type of adjustment information is information indicative of payments made to or received for child-support and amount of time (in months/years) that remain for the user to make these payments. This type of adjustment information negatively impacts the user's simulated credit score, e.g., by resulting in a downward adjustment of the simulated credit score.

These various types of adjustment information are used in increasing and/or decreasing a computed value of a simulated credit score. Credit management server 108 increases the simulated credit score by a predefined amount (e.g., by a value of fifty, by twenty-five percent) when a particular type of adjustment information exceeds a threshold value. Credit management server 108 decreases the simulated credit score by a predefined amount (e.g., by a value of fifty, by twenty-five percent) when a particular type of adjustment information is less than a threshold value.

The below Table 2 provides an example of proprietary adjustment rules, e.g., a mapping of adjustment conditions to be satisfied by particular types of adjustment information and amount by which a simulated credit score is adjusted (e.g., increased and/or decreased), upon detection of satisfaction of the adjustment condition.

TABLE 2

| Adjustment Condition | Adjustment Value |
|---|---|
| Average balance in financial | Increase simulated credit score |
| accounts >= threshold balance | by 25% |
| One or more financial account being | Increase simulated credit score |
| opened for a length of time that | by 10% |
| exceeds a threshold amount of time | |
| One or more financial accounts being | Simulated credit score remains |
| opened for a length of time that is | unadjusted |
| less than a threshold amount of time | |
| Average balance in financial accounts < | Decrease simulated credit score |
| threshold balance | by 15% |

As shown in the above Table 2, data repository 109 stores a mapping of various adjustment conditions (that are based on adjustment information) for adjustment values. Following calculation of the simulated credit score 122, credit management server 108 determines whether a value of personalized score 122 is increased or decreased, e.g. based on values of adjustment information. Using credit information 116, 118 and the mapping shown in Table 2, credit management server 108 determines whether one or more of the adjustment conditions in the mapping are satisfied by the adjustment information included in credit information 116, 118.

Upon detection of an adjustment condition, credit management server 108 adjusts a value of simulated credit score 122 in accordance with the adjustment specified in the mapping. The adjusted value of the simulated credit score 122 is the new simulated credit score 122. If credit management server 108 detects satisfaction of one or more adjustment conditions associated with adjusting a value of the simulated credit score, e.g., credit management server 108 iteratively (and/or iteratively) adjusts the value of simulated credit scores, e.g., such that credit management server 108 implements adjustments to the value of simulated credit score 122 for each of the satisfied adjustment conditions.

Referring to FIG. 2, web page 130 is displayed (e.g., on client device 104), when the user of client device 104 access a uniform resource location (URL) for web page 130. Web page 130 is generated by a financial system (e.g., financial system 111 in FIG. 1) for financial accounts (e.g., brokerage accounts). The financial system is used by a user to view financial accounts and/or retirement accounts of the user, to place trades, and to view information indicative of the financial markets. The financial system includes credit management server 108. Web page 130 includes portion 132, selection of which causes the financial system to send, to credit management server 108, a request (e.g., request 114) to view aggregated credit information for the user. As described in further detail below, the aggregated credit information includes credit bureau scores, personalized credits scores, personal credit management proprietary scores, information derived from one or more of credit bureau scores, personalized credits scores, personal credit management proprietary scores, and so forth.

Referring to FIG. 3, credit management server 108 generates data for graphical user interface 140 that is rendered by client device 104. Credit management server 108 generates data for graphical user interface 140 in response to receipt of request 114. Graphical user interface 140 displays simulated credit score 142. Graphical user interface 140 also displays portion 144 with a chart of values of the user's simulated credit scores as a function of time (e.g., quarter one, quarter two, quarter three, and so forth). The simulated credit scores charted in portion 144 are generated by credit management server 144.

Graphical user interface 140 also includes portion 146 for displaying of information that qualifies simulated credit score 142, including, e.g., information specifying whether the value of simulated credit score 142 is good, very good, excellent and so forth. Graphical user interface 140 also includes visual representation 148, which is a representation of a range of simulated credit scores and indicates a location of the user's simulated credit score in the range. Graphical user interface 140 also includes control 150, selection of which causes credit management server 108 to transmit to client device 104 information indicative of a summary of credit information, (e.g., credit information 116, 118).

Referring to FIG. 4, credit management server 108 generates data for graphical user interface 160, which displays a credit summary statement (e.g., a summary of credit information) of the user. Graphical user interface 160 is an overlay of graphical user interface 140. In this implementation, the graphical user interface 160 is rendered as an overlay on the interface 140 of FIG. 3. Graphical user interface 160 displays credit bureau information 162, 164, 166 indicative of names of various credit bureaus. Credit bureau information 162 specifies a name of credit bureau server 110. Credit bureau information 164 specifies a name of credit bureau server 112. Credit bureau information 166 specifies a name of another credit bureau server that is included in system 100 and not shown in FIG. 1.

Graphical user interface 160 also displays items 168, 170, 172, 174, 176, 178, 180, 182, 184, 186, 188, 190, 192, 194 of credit information (e.g., credit information 116, 118). Items 168, 170 pertain to address information of the user. Item 172 pertains to inquiries (e.g., credit checks and credits pulls) that were obtained by the various credit bureaus for the user. Items 174, 176, 178, 180, 182, 184, 186, 188, 190, 192, 194 pertain to account activity of the user, including, e.g., information specifying a date an account (e.g., financial account, a credit card account, a mortgage account, etc.) was opened, information specifying a date an account was closed, and information specifying a name of an institution that maintains the account.

Credit management server 108 uses credit information 116, 118 in identifying items 168, 170, 172, 174, 176, 178, 180, 182, 184, 186, 188, 190, 192, 194 of credit information. Credit information 116, 118 includes information indicative of one or more of items 168, 170, 172, 174, 176, 178, 180, 182, 184, 186, 188, 190, 192, 194. Credit management server 108 parses credit information 116, 118 to identify items 168, 170, 172, 174, 176, 178, 180, 182, 184, 186, 188, 190, 192, 194 for display in the summary.

Graphical user interface 160 also displays markings in association with the various items. The markings specify which of the credit bureaus, from which credit information is received, had a record of the item of credit information. Graphical user interface 160 displays markings 196, 198, 200 to indicate that each of the credit bureaus specified by credit bureau information 162, 164, 166 had a record of item 168. Credit management server 108 determine that each of the credit bureaus specified by credit bureau information 162, 164, 166 had a record of item by determines that the credit information received from each of these credit bureaus included information indicative of item 168.

Through the summary displayed in graphical user interface 160, a user monitors the user's credit health. Credit management server 108 enables a user to monitor the user's credit health and compare current credit information against historical credit information, which promotes acceptable credit health. Credit management server 108 allows the customers to view and to monitor a simulated credit score based on the data from each credit bureau. As shown in graphical user interface 160, a user may view a quick summary of all open accounts reported from bureaus. Credit management server 108 also provides a user with statistics and news headlines on the topic of safeguarding data and security threats. Credit management server 108 also provides a user with recent activity changes since the last check inquires, including, e.g., account open changes and address changes.

Referring to FIG. 5, credit management server 108 generates data for graphical user interface 210, which displays a listing 212 of recent activities that pertain to the credit of a user. The recent activities include recent inquiry information 214, e.g., information indicative of inquiries into the user's credit. The recent activities also include account opening information 216, e.g., information indicative of financial accounts and/or credit card accounts that have been opened on behalf of the user. The recent activities also include account status change information 218, including, e.g., information indicative of a change in an account of the user (e.g., a change from open to closed).

Credit management server 108 uses the credit information received from the credit bureaus in identifying information to be displayed in graphical user interface 210. For example, the credit information received by credit management server 108 includes information indicative of recent credit activities of the user, e.g., recent inquiries, account openings, and account status changes. Credit management server 108 parses the received credit information to obtain the information indicative of the recent credit activities. Credit management server 108 parses information specifying the recent credit activities into various categories (e.g., inquiries, account open, account status change) and displays the parsed information with the associated categories in graphical user interface 210. Graphical user interface 210 also includes control 219, selection of which enables a user to review a credit bureau report online and/or to review a credit bureau score (e.g., from one credit bureau or from a plurality of credit bureaus).

Referring to FIG. 6, credit management server 108 generates data for graphical user interface 220 for displaying options indicative of various actions that user can instruct credit management server 108 to take and/or instruct various credit bureaus to perform. Graphical user interface 220 is rendered by client device 104. Graphical user interface 220 includes action information 222, 224, 226, 228, 230, 232, 234, indicative of one or more actions that a user can request to be performed by credit management server 108 and/or by a credit bureau server.

Graphical user interface 220 also includes selectable portions 242, 244, 246, which are associated with action information 222, 224, 226, respectively. Upon selection of one or more of selectable portions 242, 244, 246, client device 104 (FIG. 1) sends to credit management server 108 a request to perform the action specified by the action information associated with the selected portion of graphical user interface 220.

Graphical user interface 220 also includes credit bureau information 236, 238, 240 specifying names of one or more credit bureaus. The actions specified in action information 228, 230, 232, 234 are performed with regard to one or more of the credit bureaus specified by credit bureau information 236, 238, 240.

Graphical user interface 220 includes selectable portions 242, 244, 246, which are associated with action information 228 and credit bureau information 236, 238, 240, respectively. Selection of one or more selectable portions 242, 244, 246 indicates a user request to perform the action specified by action information 228 with regard to the credit bureau associated with the selection portion(s). Client device 104 receives information indicative of a selection of selectable portion 244. In response, client device 104 generates a request to perform the action specified by action information 288 (e.g., an action of adding fraud alert) for the credit bureau associated with selectable portion (e.g., for the credit bureau specified by credit bureau information 238). Client device 104 sends the generated request to credit management server 108. In response, credit management server 108 sends to the credit bureau specified by credit bureau information 238 a notification to add fraud alert to the account of the user of client device 104.

Credit management server 108 determines which credit bureaus to be represented in graphical user interface 220, e.g., based on a user's selection of credit bureaus, based on the credit bureaus that transmitted credit information to credit management server 108, and/or based on instructions specified by an operator of credit management server 108.

Through graphical user interface 220, credit management server 108 enable a user to interact with various credit bureaus and with credit management server 108. These interactions secure customer data, fix customer data and/or provide tools to keep credit health healthy.

For example, action information 226 specifies the setting of bill payment reminders and linking a customer to a bill pay feature. Action information 222 sets a reminder to run credit check quarterly. Action information 224 enables a user to add new accounts approved by customer to full view for active monitoring. Action information 228 enables the user to add/delete fraud alert for the customer's social security number (SSN) with various credit bureaus. Action information 230 enables a customer to add/remove a freeze status with various credit bureaus for the customer's SSN. Action information 232 enables a customer to add freeze with various credit bureaus for the customer's dependents SSN (to only be removed by dependent after age of 16). Action information 234 enables a customer to report fraudulent activity. For example, once a customer has reviewed his/his credit health, identified credit accounts that are believed to be fraudulent, action information 234 (and associated selectable portions) allow a customer to report fraud to various credit bureaus. This gives the customer a one-stop protection area to manage all actions regarding identity protection. Action information 234 also provides the consumer with tools to clean up a credit report discrepancy by attaching corrective documentation.

Referring to FIG. 7, credit management server 108 generates data for graphical user interface 250, which displays score simulator tool 252 for generating a simulation of how one or more actions with regard to one or more of the user's accounts will affect the user's simulated credit score. Score simulator tool 252 displays, for a user, alternatives for credit account choices and information specifying how these alternatives impact the user's credit score and financial benefits of these alternatives. Score simulator tool 252 is an interactive tool that shows how the customer's score changes when they make adjustments to their accounts such as opening a new account, closing an older account, paying off account balance or paying minimum. Credit management server 108 also generates recommendations for changes to make to accounts, based on balances, interest rates and cash back options. Credit management server 108 also offers alternative credit cards which could reduce interest rates charges, or provide additional cash back options into a user's investment, retirement or college saving plans.

Score simulator tool 252 displays action information 254, 246, 258, indicative of one or more actions that may be performed with regard to one or more of accounts 260, 262, 264, 266, 268. The actions specified by action information 254, 246, 258 include an action of paying a minimum payment amount, an action of paying off a balance, and an action of closing an account, respectively.

Score simulator tool 252 also includes selectable portions, including, e.g., selection portions 274, 276, 278. Selection of selectable portion 278 notifies credit management server 108 that the user is requesting that credit management server 108 generate a simulated credit score (e.g., and/or an updated simulated credit score), e.g., based on a simulated action of closing account 268. The user is requesting that credit management system 108 update the simulated credit score of the user, e.g., based on the user closing account 268. Score simulator tool 252 includes score range 270 for display of simulated credit scores, e.g., in a range of credit scores that range from a value of one-hundred to a value of nine hundred. Upon selection of selectable portion 278, credit management server 108 updates the simulated credit score based on the user closing account 268. Graphical user interface 250 also includes portion 272 for display of saving simulator information, e.g., information specifying actions that are recommended that the user take to increase an amount of savings of the user.

Credit management server 108 also includes a rules engine for identifying actions that will improve a credit score (e.g., a simulated credit score) of a user. The rules engine aggregates together various obligation information, e.g., credit card information, loan information and mortgage information. Credit management server 108 aggregates together the obligation information based on credit information 116, 118 and based on information in financial account(s) 120. Credit management server 108 retrieves, from data repository 109, interest rates for each obligation specified in the obligation information. Credit management server 108 also requests, from one or more of credit bureau servers 110, 112, interest rates for various obligations specified in the obligation information.

For one or more of the outstanding obligations, credit management server 108 computes a credit value ratio, e.g., a value indicative of a ratio of available credit to outstanding credit, such as a ratio of available balances for home equity to outstanding balances for home equity and a ratio of available balances for credit cards to outstanding balances for credit cards. Credit management server 108 compares the credit value ratios to each other. The rules engine includes a rule to pay off lowest outstanding balances (and/or outstanding balances associated with the lowest outstanding balance value ratios), if the user's financial accounts include sufficient funds to make a minimum payment amount for the obligation. In an example, credit management server 108 identifies one of the obligations with a lowest outstanding balance value ratio, relative to the outstanding balance value ratios of other of the obligations. The minimum payment amount for the obligation (with the lowest outstanding balance value ratio) is $250 and cash available in one or more of financial account(s) 120 is greater than $1000. Credit management server 108 recommends to the user to make automatic extra payment that month of $250 for the obligation. Credit management server 108 re-performs the computation at a later time (e.g., thirty days later) and if extra cash allows makes another extra payment for the same obligation or for a new obligation with the lowest outstanding balance value ratio.

Credit management server 108 also implements numerous other techniques to identify opportunities to increase a credit score of a user (e.g., either a bureau credit score or a simulated credit score). Credit management server 108 identifies late payment history, including date of late payment and notification for setting up bill payment. Late payments negatively impact a credit score. Improvement in the credit score occurs after a few months of current payments.

Credit management server 108 also analyses a number of accounts (of a user) and open dates of the account. Older accounts with the same company with good credit positively impact a credit score, while too many recent open accounts can negatively impact credit scores. No open accounts can negatively impact credit scores. To improve a user's credit score, credit management server 108 generates a recommendation of keeping older accounts in good order and open and inclosing those accounts that are not positively adding to a credit score. In generating a recommendation to close an account, credit management server 108 analyses various factors, including, e.g., the open accounts and the balances in these accounts.

Credit management system 108 also generates recommendations that a user pay down balances for large debt. Credit management system 108 also generates a recommendation that user make an extra payment or payment in full (on a debt) if possible to increase the user's credit score. Credit management system 108 also generates a recommendation that a user pay down loans from finance companies to increase a credit score. Credit management system 108 also generates a recommendation that a user consolidate balances to a low interest rate card leaving fewer accounts with balances, e.g., to improve a user's credit score. Credit management system 108 analyses interest rates being charged on credit cards used by the user and offers alternative credit cards, e.g., with lower interest rates.

Referring to FIG. 8, credit management server 108 executes process 280 in aggregating and managing credit information. In operation, credit management server 108 retrieves (282) credit information, e.g., from one or more of credit bureau servers 110, 112. Credit management server 108 also retrieves (284) financial account information, e.g., from financial account(s) 120. Using the retrieved credit information and the retrieved financial account information, credit management server 108 generates (286) a simulated credit score. Credit management server 108 may also use adjustment information to adjust a value of the simulated credit score. Credit management server 108 also generates (288) suggestions for how the user can improve the credit score.

### Based

Referring to FIG. 9, credit management server 108 implements process 290 in generating simulated credit scores. In operation, credit management server 108 receives (292) a request to access the credit score simulator. In response, credit management server 108 accesses (294) credit information, e.g., from one or more of credit bureau servers 110, 112 and/or from data repository 109. Credit management server 108 also accesses, from data repository 109, financial account information for financial account(s) 120. Using the credit information and the financial account information, credit management server 108 determines (296) one or more actions the user could take to improve the user's credit score (e.g., either a credit bureau score or the simulated credit score). For example, credit management server 108 may determine one or more accounts with outstanding balances. The actions to improve the credit score may be one or more actions to reduce the outstanding balances. Credit management server 108 may also generates other types of actions to improve the user's credit score, e.g., the above described suggestions and recommendations that may be generated by credit management server 108. Credit management server 108 generates these suggestions and recommendations based on performance of an analysis of the user's credit information and the user's financial account information.

Based on the determined actions, credit management server 108 generates (298) simulation options for execution of one or more of the determined actions. Credit management server 108 generates data for a graphical user interface that displays the generated simulation options. The user may select one or more of the simulation options, displayed in the graphical user interface. Upon selection, the user's client device sends, to credit management server 108, information indicative of the selected simulation options. Credit management server 108 receives (300) the user's selection of at least one of the simulation options. Using the selected simulation option, credit management server 108 re-calculates (302) the user's credit score (e.g., the simulated credit score or the credit bureau credit score).

FIG. 10 is a block diagram of components 310 of the system 100. User devices 312 can be any sort of computing device capable of taking input from a user and communicating over a network (not shown) with server 110 and/or with other client devices. For example, user device 312 can be a mobile device, a desktop computer, a laptop, a cell phone, a personal digital assistant (“PDA”), a server, an embedded computing system, a mobile device and so forth. User devices 312 include monitor 314 which render visual representations of interface 316.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from user device 312 via interfaces 316, including, e.g., graphical user interfaces. Interfaces 316 can be any type of interface capable of receiving information over a network, such as an Ethernet interface, a wireless networking interface, a fiber-optic networking interface, a modem, and so forth. Server 110 also includes a processor 316 and memory 318. A bus system (not shown), including, for example, a data bus and a motherboard, can be used to establish and to control data communication between the components of server 110.

Processor 316 may include one or more microprocessors. Generally, processor 316 may include any appropriate processor and/or logic that is capable of receiving and storing data, and of communicating over a network (not shown). Memory 318 can include a hard drive and a random access memory storage device, such as a dynamic random access memory, machine-readable media, or other types of non-transitory machine-readable storage devices.

Components 310 also include storage device 320, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

1. A computer-implemented method comprising:
receiving, by a credit management system, balance information indicative of account balances in one or more financial accounts of a user;
receiving, by the credit management system, debt information of the user, with the debt information specifying balance information indicative of outstanding debts in the one or more financial accounts of the user;
accessing by the credit management system a table of pre-defined personal credit management proprietary scores that are mapped to pre-defined score conditions, with the pre-defined score conditions based on values of account balances and credit bureau scores;
identifying that one of the score conditions in the table is satisfied by one or more of the balance information and the debt information in the one or more financial accounts of the user; and
selecting, from the table, a personal credit management proprietary score according to the identified one of the score conditions; storing the selected personal credit management proprietary score with information corresponding to the user.

2. The computer-implemented method of claim 1, further comprising:
adjusting a value of the personal credit management proprietary score based on proprietary adjustment rules.

3. The computer-implemented method of claim 1, further comprising:
retrieving, by the credit management system from a plurality of credit bureau systems, credit bureau scores of the user;
generating, based on the personal credit management proprietary score and based on the retrieved credit bureau scores, a simulated credit score for the user; and
adjusting a value of the simulated credit score based on one or more of credit information of the user and account information of the user.

4. (canceled)

5. The computer-implemented method of claim 3, further comprising:
retrieving, by the credit management system from a plurality of credit bureau systems, credit bureau scores of the user; and
assigning weighted values to one or more of the personal credit management proprietary score and the retrieved credit bureau scores;
wherein generating the simulated credit score for the user comprises:
computing a weighted average of the personal credit management proprietary score and one or more of the retrieved credit bureau scores, with the weighted average being in accordance with the weighted values assigned to the one or more of the personal credit management proprietary score and the retrieved credit bureau scores.

6. The computer-implemented method of claim 1, further comprising:
receiving, from a computing device used by the user, information indicative of a selection of one or more actions for one or more credit bureau systems to perform;
identifying, from the received information, one or more of the credit bureau systems to be notified of the user's request for performance of the one or more actions; and
transmitting, to the identified one or more of the credit bureau systems, a notification message of the user's request for performance of the one or more actions.

7. A computer program product tangibly stored on a computer readable hardware storage device, the computer program product comprising instructions for causing a credit management system to perform operations comprising:
receiving, by the credit management system, balance information indicative of account balances in one or more financial accounts of a user;
receiving, by the credit management system, debt information of the user, with the debt information specifying balance information indicative of outstanding debts in the one or more financial accounts of the user;
accessing by the credit management system a table of pre-defined personal credit management proprietary scores that are mapped to pre-defined score conditions, with the pre-defined score conditions based on values of account balances and credit bureau scores;
identifying that one of the score conditions in the table is satisfied by one or more of the balance information and the debt information in the one or more financial accounts of the user; and
selecting, from the table, a personal credit management proprietary score according to the identified one of the score conditions; storing the selected personal credit management proprietary score with information corresponding to the user.

8. The computer program product of claim 7, wherein the operations further comprise:
adjusting a value of the personal credit management proprietary score based on proprietary adjustment rules.

9. The computer program product of claim 7, wherein the operations further comprise:
retrieving, by the credit management system from a plurality of credit bureau systems, credit bureau scores of the user;
generating, based on the personal credit management proprietary score and based on the retrieved credit bureau scores, a simulated credit score for the user; and
adjusting a value of the simulated credit score based on one or more of credit information of the user and account information of the user.

10. (canceled)

11. The computer program product of claim 9, wherein the operations further comprise:
retrieving, by the credit management system from a plurality of credit bureau systems, credit bureau scores of the user; and
assigning weighted values to one or more of the personal credit management proprietary score and the retrieved credit bureau scores;
wherein generating the simulated credit score for the user comprises:
computing a weighted average of the personal credit management proprietary score and one or more of the retrieved credit bureau scores, with the weighted average being in accordance with the weighted values assigned to the one or more of the personal credit management proprietary score and the retrieved credit bureau scores.

12. The computer program product of claim 7, wherein the operations further comprise:
receiving, from a computing device used by the user, information indicative of a selection of one or more actions for one or more credit bureau systems to perform;
identifying, from the received information, one or more of the credit bureau systems to be notified of the user's request for performance of the one or more actions; and
transmitting, to the identified one or more of the credit bureau systems, a notification message of the user's request for performance of the one or more actions.

13. An apparatus comprising:
a processor of a credit management system; and
a computer program product stored on a computer readable hardware storage device, the computer program product comprising instructions for causing the processor to perform operations comprising:
receiving, by the credit management system, balance information indicative of account balances in one or more financial accounts of a user;
receiving, by the credit management system, debt information of the user, with the debt information specifying balance information indicative of outstanding debts in the one or more financial accounts of the user;
accessing by the credit management system a table of pre-defined personal credit management proprietary scores that are mapped to pre-defined score conditions, with the pre-defined score conditions based on values of account balances and credit bureau scores;
identifying that one of the score conditions in the table is satisfied by one or more of the balance information and the debt information in the one or more financial accounts of the user; and
selecting, from the table, a personal credit management proprietary score according to the identified one of the score conditions; storing the selected personal credit management proprietary score with information corresponding to the user.

14. The apparatus of claim 13, wherein the operations further comprise:
adjusting a value of the personal credit management proprietary score based on proprietary adjustment rules.

15. The apparatus of claim 13, wherein the operations further comprise:
retrieving, by the credit management system from a plurality of credit bureau systems, credit bureau scores of the user;
generating, based on the personal credit management proprietary score and based on the retrieved credit bureau scores, a simulated credit score for the user; and
adjusting a value of the simulated credit score based on one or more of credit information of the user and account information of the user.

16. (canceled)

17. The apparatus of claim 15, wherein the operations further comprise:
retrieving, by the credit management system from a plurality of credit bureau systems, credit bureau scores of the user; and
assigning weighted values to one or more of the personal credit management proprietary score and the retrieved credit bureau scores;
wherein generating the simulated credit score for the user comprises:
computing a weighted average of the personal credit management proprietary score and one or more of the retrieved credit bureau scores, with the weighted average being in accordance with the weighted values assigned to the one or more of the personal credit management proprietary score and the retrieved credit bureau scores.

18. The apparatus of claim 13, wherein the operations further comprise:
receiving, from a computing device used by the user, information indicative of a selection of one or more actions for one or more credit bureau systems to perform;
identifying, from the received information, one or more of the credit bureau systems to be notified of the user's request for performance of the one or more actions; and
transmitting, to the identified one or more of the credit bureau systems, a notification message of the user's request for performance of the one or more actions.

19. The computer-implemented method of claim 1, wherein the selected personal credit management proprietary score comprises a numeric value.
